(19) United States
(12) Patent Application Publication
(10) Pub. No.: US 2025/0249956 A1
(43) Pub. Date: Aug. 7, 2025

(54) METHOD FOR OPERATING A ROTATION ANGLE SENSOR UNIT FOR USE IN STEERING SYSTEMS OF MOTOR VEHICLES, ROTATION ANGLE SENSOR UNIT, STEERING SYSTEM AND MOTOR VEHICLE

(71) Applicants: thyssenkrupp Presta AG, Eschen (LI); thyssenkrupp AG, Essen (DE)

(72) Inventors: Miklós ARÁNYI, Altstaetten (CH); Andras TOTH, Gyál (HU); Bence BODNÁR, Kiskunfélegyháza (HU)

(73) Assignees: thyssenkrupp Presta AG, Eschen (LI); thyssenkrupp AG, Essen (DE)

(21) Appl. No.: 19/042,377

(22) Filed: Jan. 31, 2025

(30) Foreign Application Priority Data
Feb. 2, 2024 (BE) BE 2024/5067

(51) Int. Cl. B62D 15/02; G01B 21/26

(52) U.S. Cl. CPC B62D 15/022; G01B 21/26

(57) ABSTRACT

A method for operating a rotation angle sensor unit for steering systems of motor vehicles, wherein the rotation angle sensor unit has an intermeshing gearwheel pair, wherein a first gearwheel is provided to be connected to the steering component for conjoint rotation and a second gearwheel is mounted in a rotationally fixed manner with respect to the first gearwheel, wherein two first and two second rotation angle sensors are assigned to the first and second gearwheels respectively, and the rotation angle sensor unit comprises a control unit with two independent control units, wherein, for operation of the rotation angle sensor unit with the predetermined vehicle safety integrity level, at the time of initialization of the rotation angle sensor unit each controller unit determines an initial absolute rotation angle for the steering component, and the initial absolute rotation angles are initially synchronized once, wherein each controller unit after initial synchronization continuously determines a first and second absolute rotation angle of the steering component from rotation angle data of a first rotation angle sensor on the one hand and from rotation angle data of a second rotation angle sensor on the other hand and combines these in a plausibilized manner to form an absolute rotation angle.

### CROSS REFERENCE TO RELATED APPLICATION

This application is a U.S. Non-Provisional that claims priority to Belgian Patent Application No. BE 2024/5067, filed Feb. 2, 2024, the entire content of which is incorporated herein by reference.

### FIELD

The present disclosure relates to a method for operating a rotation angle sensor unit for use in motor vehicle steering systems, a rotation angle sensor unit, a steering system and a motor vehicle.

### BACKGROUND

For safety-relevant electrical or electronic systems in motor vehicles, such as electrically assisted or autonomous driving and braking functions, it is common for such systems to comply with certain safety standards.

For motor vehicles, the so-called ASIL risk classification of the superordinate ISO standard ISO 26262 has become established in this context. Safety-critical applications in particular, such as steer-by-wire steering systems and systems for autonomous driving, generally require very strict safety requirements, for example in accordance with the highest level “D” of the ASIL risk classification (ASIL-D; ASIL: Automotive Safety Integrity Level). For example, redundant signal acquisition and corresponding plausibility checks of the signals are required for the highest level D in order to minimize the risk of a system failure with the corresponding consequences.

DE 10 2014 208 658 A1, for example, discloses a rotation angle sensor in which the rotation angle of the steering shaft is determined by two intermeshing gear rims. It is envisaged that a first gearwheel is to be attached to the rotatable component for conjoint rotation and coaxially with respect to the axis of rotation of the rotating component. The second gearwheel has an axis of rotation parallel to the first gearwheel and engages with an outer gear rim in the outer gear rim of the first gearwheel. When the second gearwheel rotates as a result of rotation of the first gearwheel coupled to the rotating component, the second gearwheel also moves in the axial direction through a screw thread provided on the axis of rotation and meshing with the second gearwheel. The absolute rotation angle of the steering shaft or the steering wheel coupled to it can be determined by detecting the rotation angle of the two gearwheels and the position of the second gearwheel on the screw thread.

According to DE 10 2014 208 658 A1, it is possible to check the plausibility of the absolute rotation angle via the axial position of the second gearwheel, wherein the absolute rotation angle is determined according to the vernier principle.

The rotation angle sensor for a steering shaft proposed in DE 10 2008 033 236 A1 comprises several gearwheels for determining the absolute rotation angle according to the vernier principle. However, the sensor known from this is only ASIL-C compliant.

DE 10 2014 105 682 A1 discloses a method in which a rotor position of a rotor of a servomotor of an auxiliary power steering system is also used to check the plausibility of a vernier-based rotation angle sensor. Sensor values suitable for ASIL-D can be generated. However, an additional servomotor is always required in this case.

Thus a need exists to provide a new, in particular improved method for operating a rotation angle sensor unit which is intended for use in motor vehicle steering systems. In particular, a method is to be provided which, with a comparatively simple rotation angle sensor unit, enables a plausibility check, in particular according to the ASIL-D integrity level, of determined absolute rotation angles and/or which is comparatively reliable with regard to operation at a predetermined vehicle safety integrity level, in particular ASIL-D, and can offer improved reliability. Furthermore, a rotation angle sensor unit, a steering system and a motor vehicle are to be provided.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic representation of a steering system of a motor vehicle.

FIG. 2 is a schematic representation of the steering system with a rotation angle sensor unit.

FIG. 3 is a flowchart of an embodiment according to the method.

FIG. 4 is a process sequence for determining an absolute rotation angle of a steering shaft or steering wheel.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to one embodiment, a method is provided for operating a rotation angle sensor unit that is set up for use in motor vehicle steering systems. In particular, the method is intended to enable operation at a predetermined vehicle safety integrity level, in particular ASIL-D. In particular, the method is set up to determine an absolute rotation angle, i.e. in particular a plausibilized absolute rotation angle, of a steering component of a motor vehicle, wherein the absolute rotation angle is determined in conformity with ASIL-D in particular.

The rotation angle sensor unit is designed to determine the absolute rotation angle of a steering component, in particular the absolute rotation angle of a steering system or steering system, in particular the steering wheel or a steering shaft. In particular, the rotation angle sensor unit is designed and intended for use in a so-called steer-by-wire steering system.

Steering systems in motor vehicles are generally designed in such a way that a steering angle, i.e. a rotation of the steering wheel or an associated steering shaft, can comprise several clockwise or anti-clockwise rotations. This means that the rotation angle cannot be described completely or unambiguously by an angle range from 0° to 360°. This means that in order to determine the total rotation angle, both the number of complete revolutions and the rotation angle that exceeds one complete revolution or falls short of one complete revolution must be determined. The same applies to various other rotating or rotatable components in motor vehicles.

In this context and in the sense of the underlying invention, a relative rotation angle is understood to mean the angular range between 0° and 360° assigned to a non-complete revolution. For the purposes of the underlying invention, an absolute rotation angle is understood to be that angular range which, in addition to the respective relative rotation angle, also includes the number of complete revolutions. This is explained using an example. If, for example, a steering wheel is turned by 1¼ revolutions, this results in an angle of +/−360°/4, i.e. +/−90°, for the relative rotation angle, and an angle of +/−360°+90°, i.e. +/−450°, for the absolute rotation angle, depending on the direction of rotation.

Particularly in steering systems, such as steer-by-wire steering systems, in which a rotary movement of the steering wheel is not transmitted mechanically but electrically to the steered wheels, it is necessary to be able to reliably and safely determine the absolute rotation angle of the steering wheel or the steering shaft.

The method according to the invention is based on a rotation angle sensor unit which enables the absolute rotation angle, in particular a plausibilized combined absolute rotation angle, or absolute rotation angle, of a turnable or rotatable steering component of a steering system to be determined.

The rotation angle sensor unit comprises a gearwheel pair, to be understood as a rotor pair, the gearwheels of which have parallel axes of rotation and different diameters. The gearwheels of the gearwheel pair are intermeshing or mesh with each other, in particular in that circumferential gear rims are enmeshed with each other. This means that the rotation of one of the gear rims causes the other gearwheel to rotate due to the intermeshing mechanical coupling. The mechanical coupling enables a comparatively reliable, backlash-free transmission of the rotational movements. The absolute rotation angle can be determined from the rotational movements of the gearwheels, in particular based on the vernier principle. An example for determining an absolute rotation angle is described in the aforementioned document DE 10 2008 033 236 A1.

In the rotation angle sensor unit provided for implementing the method proposed herein, a first gearwheel of the gearwheel pair is intended to be connected to the steering component for conjoint rotation and in a rotationally synchronized manner. A second gearwheel of the gearwheel pair is rotatably mounted in a fixed position relative to the first gearwheel.

Furthermore, two first rotation angle sensors are assigned to the first gearwheel and two second rotation angle sensors are assigned to the second gearwheel, each of which rotation angle sensors is set up to detect a relative rotation angle of the respective gearwheel. The rotation angle sensors can in particular be magnet-based sensors, optical sensors, eddy current sensors or other sensors for detecting the rotation angle of the respective gearwheel.

The rotation angle sensor unit also comprises a control unit with two independent controller units, wherein a first and second rotation angle sensor are assigned to each controller unit. Furthermore, the controller units are each set up to determine and provide an absolute rotation angle of the steering component from rotation angle data or rotation angle signals of a respectively assigned first and/or second rotation angle sensor. In particular, each controller unit can be connected to a first and second rotation angle sensor by means of signalling technology in order to receive corresponding rotation angle data or rotation angle signals from the two rotation angle sensors for further processing, in particular for determining an absolute rotation angle.

To determine the absolute rotation angle, each controller unit can include an overrun counter with which the number of complete revolutions (360°) or the (relative number) of total revolutions of the respective gearwheel can be detected.

In particular, the controller units can have independent circuits for determining the rotation angle from the rotation angle data. Corresponding circuits can either be implemented on a common chip or a common integrated circuit, or the circuits can be implemented on different, independent chips and/or control units.

The controller units are preferably set up to determine two independent absolute rotation angles, each dependent on the rotation angle of one of the gearwheels or on rotation angle data of a respective first rotation angle sensor of the first gearwheel and on rotation angle data of a respective second rotation angle sensor of the second gearwheel.

The two independently operating circuits can, in particular, be arranged in a common housing or in separate housings. The circuits can be implemented as a structural unit with the gearwheels, or the circuits can be formed separately and connected to the rotation angle sensors by data lines, in particular a data bus.

By using independent controller units, it is possible to determine absolute rotation angles in compliance with ASIL-B or ASIL-D.

According to the method, it is provided that for operation of the rotation angle sensor unit with the specified vehicle safety integrity level, in particular an integrity level ASIL-D, at the time of initialization of the rotation angle sensor unit or when the rotation angle sensor unit is started or switched on,
each controller unit determines an initial, i.e. an absolute rotation angle for the steering component determined at the time of initialization, using rotation angle data from both the respectively assigned first and the respectively assigned second rotation angle sensor,
the controller units are initially synchronized once with regard to the determined initial absolute rotation angle,
   and each controller unit after initial synchronization
continuously determines a first and second absolute rotation angle of the steering component from rotation angle data of an assigned first rotation angle sensor on the one hand and from rotation angle data of an associated second rotation angle sensor on the other hand, checks these for plausibility and combines them to form an absolute rotation angle, which is in particular an absolute rotation angle of the steering component.

The absolute rotation angle at the time of initialization can be determined in particular according to the vernier principle, wherein the rotation angles of the first and the respective gearwheel can be used. In particular, each of the independent controller units can determine an absolute rotation angle that has the ASIL-B integrity level from the rotation angle data of a first gearwheel or a first rotation angle sensor and from the rotation angle data of an assigned second gearwheel or a second rotation angle sensor. By synchronizing, in particular checking the plausibility, verifying, in particular by comparing, the two ASIL-B rotation angles, it is possible to determine rotation angles that conform to the ASIL-D integrity level.

After synchronization, each of the control units determines in particular two absolute rotation angles, wherein one of the absolute rotation angles can be determined based on or from rotation angle data of the first gearwheel or the respective first rotation angle sensor, and a second of the rotation angles can be determined based on or from rotation angle data of the second gearwheel or the respective second rotation angle sensor.

As a result of the initial synchronization to ASIL-D, the two absolute rotation angles each have at least the ASIL-B integrity level. An ASIL-D classified absolute rotation angle can be determined from the corresponding two ASIL-B rotation angles of a controller unit by plausibility checking, in particular by combining the two rotation angles to form an absolute rotation angle, especially if the plausibility check, which can include a comparison of the two rotation angles, shows that a deviation of the two rotation angles is smaller than a specified limit value for the rotation angle deviation. The term “absolute rotation angle” is to be understood as an angle that the corresponding controller unit can provide as an absolute rotation angle of the steering component of the motor vehicle, in particular to other electronic components of the motor vehicle.

It is therefore possible that, after initial synchronization, both controller units can each determine or provide an absolute rotation angle of the ASIL-D integrity level. This has the particular advantage that even if one of the controller units fails, an ASIL-D-compliant absolute rotation angle can still be provided.

Preferably, the controller units or sensor units are components with so-called TPO properties (TPO: true power on), wherein a TPO sensor or a corresponding signal has the property that it can provide a specific, in particular correct, value immediately after switching on or after initialization. With such TPO properties, an initial absolute rotation angle can therefore be provided at the time of initialization. In embodiments, it may be provided that the rotation angle sensor unit is set up in such a way that an initial absolute rotation angle can be provided without the need for a continuous, in particular standby supply, in particular from an external energy source of the motor vehicle.

According to one embodiment, as already discussed above, the vehicle safety integrity level corresponds to the ASIL-D classification. In particular, after initial synchronization, each of the controller units can determine or generate a signal corresponding to the ASIL-D classification for the absolute rotation angle or an ASIL-D-compliant absolute rotation angle of the steering component.

According to embodiments, it may be provided that the steering component is a steering shaft, a steering wheel or a steered wheel of the motor vehicle. In particular due to the fact that the proposed rotation angle sensor unit with the method proposed herein is suitable for continuing to provide an ASIL-D-compliant absolute rotation angle even if one of the controller units fails, the proposed method is suitable for use in steering systems, be it the absolute rotation angle of the steering wheel or the rotation angle of a steered wheel, in particular derived therefrom.

In accordance with embodiments, it may be provided that each of the controller units, at the time of initialization,
determines a first difference between the initial absolute rotation angle and an initial relative rotation angle of the first gearwheel,
determines a second difference between the initial absolute rotation angle and an initial relative rotation angle of the second gearwheel,
and stores the first and second difference as the first and second absolute angle offset.

Here, the initial absolute rotation angle is to be understood as the absolute rotation angle of the respective gearwheel that is present at the time of initialization. The initial relative rotation angle should be understood as the rotation angle in the range between 0° and 360° that is present on the respective gearwheel at the time of initialization. The difference between the absolute rotation angle and the respective initial relative rotation angle can be used in particular to determine the number of total revolutions associated with the absolute rotation angle. From this number, the absolute angle offset and a rotation angle measured continuously after initialization, the respective absolute rotation angle, can then be determined separately for each of the gearwheels or for each of the rotation angle sensors assigned to a controller unit. It is therefore possible for each controller unit to determine two absolute rotation angles, in particular ASIL-B-compliant absolute rotation angles, from the rotation angle data of the assigned gearwheels and to check plausibility and provide an ASIL-D-compliant rotation angle from these two absolute rotation angles.

According to embodiments, it may be provided that each of the controller units continuously determines a respective first and second absolute rotation angle after determining the first and second absolute angle offset for the steering component, wherein
the first absolute rotation angle is determined based on a respective actual rotation angle of the first gearwheel and the first absolute angle offset, and
the second absolute rotation angle is determined based on a respective relative actual rotation angle of the second gearwheel and the second absolute angle offset, wherein
the respective controller unit checks the plausibility of the determined first and second absolute rotation angles or compares them for diagnostic purposes and combines them to form an absolute rotation angle of the steering component or provides or outputs an absolute rotation angle.

In the context of the present description, the actual rotation angle of a gearwheel corresponds in particular to the rotation angle detected or measured by the respective rotation angle sensor.

The actual rotation angle can be understood as a rotation angle measured by a rotation angle sensor relative to the relative rotation angle present at the time of initialization.

According to embodiments, it may be provided that, after initialization and synchronization, the first and second absolute rotation angles are calculated by the controller unit from a number of total revolutions of the first and second gearwheel, the actual rotation angle of the first and second gearwheel and the first and second absolute angle offset.

The number of total revolutions present at the time of initialization, i.e. the initial number of complete revolutions, can be determined in particular from the difference between the initial absolute rotation angle and the initial relative rotation angle of the respective rotation angle sensor. After determining the initial number of total revolutions, the number of total revolutions can be continuously updated, in particular by means of a revolution counter, which is set up to record complete revolutions starting from the initialization. If an angle of >360° or <−360° results for the actual rotation angle, the revolution counter can increment/decrement the number of total revolutions accordingly (+1 or −1 or vice versa).

According to embodiments, it may be provided that the first and second absolute rotation angles are each calculated according to the following formula:

$${α}_{1 , 2} ( β ) = \sum {n}_{1 , 2} * 360 ° + {β}_{1 , 2} + {γ}_{1 , 2} .$$

In this case:
α_{1, 2} denotes the first or second absolute rotation angle,
n_{1, 2} denotes the number of complete revolutions of the first or second gearwheel,
β_{1, 2} denotes the actual rotation angle of the first or second gearwheel, or the actual rotation angle detected by the respective rotation angle sensor, and
γ_{1, 2} denotes the first or second absolute angle offset.

This means that in order to detect or determine the absolute rotation angle after initialization (with plausibility check of the initial absolute rotation angle), the current absolute rotation angle can be determined on the basis of the rotation angle data of the respective first or second rotation angle sensor. Consequently, the relative rotation angles of the rotation angle sensors and the complete rotations or revolutions taking place from initialization can be recorded during continuous operation, from which the first and second absolute rotation angles can be determined. The first and second absolute rotation angles determined in this way can be determined as ASIL-B-compliant rotation angles, from which an ASIL-D-compliant absolute rotation angle can be determined or provided by plausibility checks.

According to embodiments, a rotation angle sensor unit is provided which is designed in accordance with the features described above. With regard to the features in question, such a rotation angle sensor unit comprises, in particular:
an intermeshing gearwheel pair with parallel axes of rotation and different diameters, wherein a first gearwheel of the gearwheel pair is provided to be connected to the steering component for conjoint rotation and in a rotationally synchronized manner and a second gearwheel of the gearwheel pair is mounted in a rotationally fixed manner with respect to the first gearwheel,
wherein two first rotation angle sensors are assigned to the first gearwheel and two second rotation angle sensors are assigned to the second gearwheel, which are each set up to detect a relative rotation angle of the respective gearwheel, and
a control unit with two independent controller units.

The controller units of the rotation angle sensor unit are each set up or programmed in such a way, or in particular are programmed after initialization in such a way, that in operation they effect a method according to one of the embodiments described herein. It is also possible that the controller units have an associated non-volatile memory on which instructions executable by a processor, in particular a microprocessor, of the controller units are stored which, when executed by the processor, bring about a method according to one of the embodiments described herein.

According to one embodiment, a computer program product is provided, comprising executable instructions which, when executed by a rotation angle sensor unit described herein, causes a method according to one of the embodiments described herein.

According to embodiments, the rotation angle sensor unit can form a rotation angle sensor unit for a motor vehicle, and wherein the absolute rotation angle, in particular the absolute rotation angle, corresponds to or is associated with an absolute (plausibilized) rotation angle of a steering shaft, a steering wheel and/or an absolute rotation angle of a steered wheel of the motor vehicle.

According to embodiments, the controller units can be implemented in a redundant control unit, in particular an electronic control unit (ECU) or in separate control units.

According to embodiments, a steering system, in particular a steer-by-wire steering system, is further provided for a motor vehicle, which comprises at least one rotation angle sensor unit according to one of the embodiments proposed herein.

According to a further embodiment, a motor vehicle is provided with at least one rotation angle sensor unit according to one of the embodiments described herein and/or with a steering system, in particular a steer-by-wire steering system, according to one of the embodiments described herein.

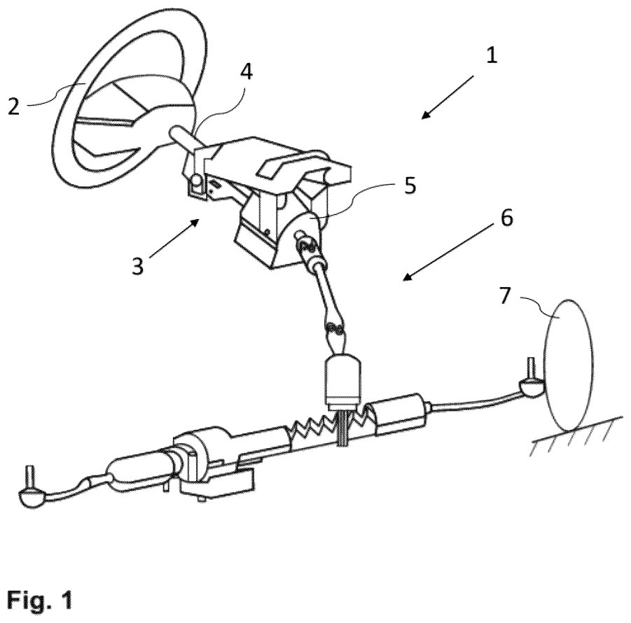

FIG. 1 shows a schematic representation of a steering system 1 or a steering system of a motor vehicle (not shown), which may be in particular, but is not limited to, an electric vehicle.

The steering system 1 comprises a steering wheel 2, a steering column 3 with a steering shaft 4, which is connected to the steering wheel 2 for conjoint rotation, a steering gear 5 connected to the steering shaft 4 and further steering components 6 connected to the steering gear 5 for transmitting a rotary movement of the steering wheel 2 or the steering shaft 4 to the steered wheels 7, of which only one is shown.

The illustration of FIG. 1 shows, without limiting the generality, a purely mechanical steering system in which steering movements are transmitted to the steered wheels 7 by mechanical components. However, the invention is not limited to such steering systems and can also be used in steering systems in which the steering movement is transmitted electrically to the steered wheels 7, so-called steer-by-wire steering systems, and in steering systems which enable both mechanical and electrical transmission of the steering movement.

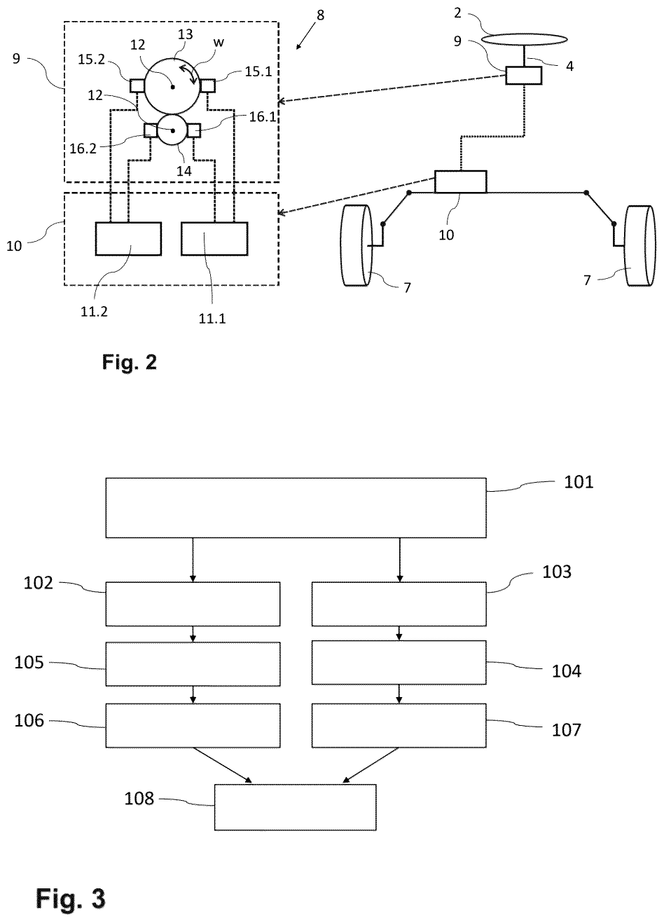

FIG. 2 shows a schematic representation of the steering system 1 with a rotation angle sensor unit 8. Although the embodiments according to the figures relate to a rotation angle sensor unit 8 which determines a rotation angle of the steering shaft 4 or the steering wheel 2, the underlying invention can also be applied or used in other ways, in particular for determining a rotation angle of the wheels.

The rotation angle sensor unit 8 comprises a sensor component 9 and a control device or control unit 10 with a first controller unit 11.1 and a second controller unit 11.2, which are also referred to together below as controller units 11.

The sensor component 9 comprises an intermeshing gearwheel pair with parallel axes of rotation 12 and different diameters. A first gearwheel 13 of the gearwheel pair is connected to the steering shaft 4 for conjoint rotation and in a rotationally synchronized manner. A second gearwheel 14 of the gearwheel pair is rotatably mounted in a fixed position relative to the first gearwheel 13, in particular in a housing, and as such is not directly connected to the steering shaft 4. When properly installed, the first gearwheel 13 is connected to the steering shaft 4 for conjoint rotation, so that the first gearwheel 13 rotates in synchronization with the steering shaft 4. The second gearwheel 13 performs a corresponding rotational movement as a result of the meshing teeth of the gearwheels 13, 14. Consequently, the first gearwheel 13 is directly coupled to the steering shaft 4 with respect to the rotational movement, and the second gearwheel 14 is only indirectly coupled via the first gearwheel 13.

Two first rotation angle sensors 15.1 and 15.2 are assigned to the first gearwheel 13 and two second rotation angle sensors 16.1 and 16.2 are assigned to the second gearwheel 14. The first rotation angle sensors 15.1 and 15.2 are each provided and set up to detect the relative rotation angle w of the first gearwheel 13. The second rotation angle sensors 16.1 and 16.2 are each set up to detect a relative rotation angle of the second gearwheel 14. In particular, the rotation angle sensors can be set up for magnetic or optical detection of the rotation angle of the respective gearwheel 13 or 14.

Each of the controller units 11 is signalled by a first rotation angle sensor 15.1 or 15.2 and a second rotation angle sensor 16.1 or 16.2. In the example shown, the first controller unit 11.1 is connected to the first rotation angle sensor 15.1 and the second rotation angle sensor 16.1 by means of signals, and the second controller unit 11.2 is connected to the first rotation angle sensor 15.2 and the second rotation angle sensor 16.2 by means of signals, so that the respective controller units 11 can detect or receive rotation angle signals from the respective rotation angle sensors.

In the example shown, the sensor component 9 is arranged at a distance from the control unit 10, wherein the sensor component 9 can be connected to the control unit 10 via data lines, in particular bus lines. It is also possible that the sensor component 9 and the control unit 10 are arranged at the same location. In particular, these can also be designed as an integrated unit and/or as units arranged in a common housing.

The controller units 11.1 and 11.2 are formed independently and can, in particular, be formed as independently operating units on a common chip or on separate chips in one or more control devices or control units 10.

The controller units 11 are each set up to determine an absolute rotation angle of the steering column 3 or the steering shaft 4, and thus of the steering wheel 2, from the rotation angle data of the respectively assigned first rotation angle sensor 15.1 or 15.2 and/or the respectively assigned second rotation angle sensor 16.1 or 16.2.

In particular, it is possible for the controller units 11 to determine an absolute rotation angle from the respective relative rotation angles of a respective first and second rotation angle sensor 15.1 and 16.1 or 15.2 and 16.2, based in particular on the vernier principle. For examples of the vernier principle, reference is made to DE 10 2014 208 658 A1 and DE 10 2008 033 236 A1 mentioned at the outset.

If the two controller units 11 were each to determine an absolute rotation angle during operation using the relative rotation angles of the two gear rims 13 and 14 based on the vernier principle and compare these continuously as is known in the prior art, the controller units 11 could determine two ASIL-B-compliant rotation angles and an ASIL-D-compliant rotation angle by plausibility checking due to the redundancy of the rotation angle sensors 15.1 or 15.2 and 16.1 or 16.2. However, one disadvantage of this method is that if one of the controller units 11 fails, only one ASIL-B-compliant rotation angle would be available. Since the rotation angle of the steering components is a safety-relevant parameter, particularly in steer-by-wire systems, ASIL-D conformity is generally required. The underlying invention now provides a possibility with which ASIL-D conformity can be achieved with the same structure of the rotation angle sensor unit, but with a different processing of the angle data than that described immediately above in the prior art, which requires a continuous comparison of the rotation angles determined in each case according to the vernier principle, even if one of the two controller units 11 fails during operation.

In contrast to the procedure described above according to the prior art, in which absolute rotation angles determined according to the vernier principle are continuously compared during operation in order to achieve ASIL-D conformity, the present invention takes a different approach.

According to the invention, it is provided that at system start or at system initialization of the controller units 11 or the rotation angle sensor unit 8, which is usually carried out each time a motor vehicle is started, each of the controller units 11 determines an initial absolute rotation angle using the angle data of the first rotation angle sensor 15.1 or 15.2 and the second rotation angle sensor 16.1 or 16.2, in particular according to the vernier principle. These initial absolute rotation angles can be determined in accordance with ASIL-B due to the redundancy of the rotation angle sensors 15.1 or 15.2 and 16.1 or 16.2. ASIL-D conformity can be achieved by synchronizing the initial absolute rotation angles determined in this way at the time of initialization, i.e. ASIL-D-compliant absolute rotation angles are available due to the synchronization at the time of initialization or system start. A single synchronization at system start is sufficient for this.

According to the method on which the invention is based, each of the controller units 11, after synchronization during operation of the rotation angle sensor unit 8, continuously determines a first and second absolute rotation angle of the steering shaft 4 from angle data or rotation angle data of an associated first rotation angle sensor 15.1 or 15.2 on the one hand and from angle data of an associated second rotation angle sensor 16.1 or 16.2 on the other hand. Due to the initial ASIL-D conformity, the first and second absolute rotation angles of each controller unit 11 determined in this way are each ASIL-B compliant, so that each controller unit 11 can provide an ASIL-D compliant rotation angle by checking the plausibility of the two ASIL-B compliant absolute rotation angles. This has the advantage that ASIL-D conformity continues to exist even if one of the controller units 11 fails.

In a specific example, a flow chart in FIG. 3 is used below to show how the controller units 11 determine the absolute rotation angles during operation. The following method steps or the following method cycle is/are carried out by each of the controller units 11. To simplify matters, the following explanations in the singular refer only to one controller unit 11, although both controller units 11 operate in the same way.

After synchronization 101 of the initial absolute rotation angles, the controller unit 11 determines in a method step 102 a first difference between the (plausibilized) initial absolute rotation angle and an initial relative rotation angle of the first gearwheel 13, wherein the initial relative rotation angle of the first gearwheel 13 can be determined from an angle signal of the first rotation angle sensor 15.1 or 15.2.

In a method step 103, the controller unit 11 determines a second difference between the (plausibilized) initial absolute rotation angle and an initial relative rotation angle of the second gearwheel 14, wherein the initial relative rotation angle of the second gearwheel 14 can be determined from an angle signal of the second rotation angle sensor 16.1 or 16.2.

In the method steps 104 and 105, the controller unit 11 stores the first and second differences as first and second absolute angle offsets.

The method steps 102 and 103 or 104 and 105 can, as shown, each be carried out simultaneously or alternatively in a suitable manner one after the other.

In the further operation of the controller unit 11, this (only) determines a first absolute rotation angle based on angular data of the first gearwheel 13 in method step 106, which, technically speaking, corresponds to the absolute rotation angle of the steering shaft 4 and is determined on the basis of angular data of the first gearwheel 13.

Furthermore, the controller unit 11 (only) determines a second absolute rotation angle based on the angular data of the second gearwheel 14 in method step 107, which, technically speaking, also corresponds to the absolute rotation angle of the steering shaft 4 and is determined from angular data of the second gearwheel 14.

Due to the initial synchronization 101, the first and second absolute rotation angles are ASIL-B compliant.

In method step 108, the controller unit 11 performs a plausibility check, in particular based on a comparison of the first and second absolute rotation angles, and can determine an ASIL-D-compliant rotation angle from the two ASIL-B-compliant rotation angles.

The method steps described after initialization are carried out continuously during further operation of the controller unit 11, wherein the rotation angle can be determined in conformity with ASIL-D throughout. This means that each of the controller units 11 can determine the rotation angle in conformity with ASIL-D. It is true that, as a rule although two ASIL-D-compliant rotation angles are generally not required, the method offers the advantage of improved reliability, because even if one of the two controller units 11 fails, in particular if plausibility checking is not (or no longer) possible for one of the controller units 11, the other controller unit 11 continues to provide ASIL-D compliance, which is not the case with the prior art procedure described above, in which a plausibility check based on a comparison of the absolute rotation angle determined by the first controller unit with a rotation angle determined by the second controller unit, both of which are ASIL-B compliant.

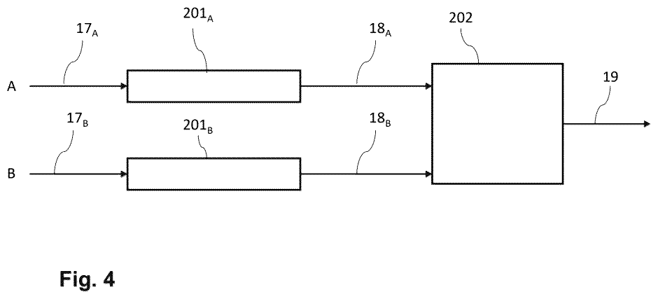

FIG. 4 shows a method sequence in the context of a specific example for determining the first and second absolute rotation angles.

The method sequence shows two channels A, B, wherein the first channel A is assigned to the determination of the first absolute rotation angle for the first gearwheel 13 and the second channel is assigned to the determination of the second absolute rotation angle for the second gearwheel 14.

The actual rotation angle β_{A} of the first gearwheel 13 determined by the first rotation angle sensor 15.1 or 15.2 serves as the input variable 17_{A} for channel A. Similarly, the actual rotation angle β_{B} of the second gearwheel 14 determined by the second rotation angle sensor 16.1 or 16.2 serves as the input variable 178 for channel B.

In method step 201_{A}, the first absolute rotation angle α₁ is determined in the first channel A, based on the following formula:

$${α}_{1} = {n}_{1} * 360 ° + {β}_{1} + {γ}_{1} .$$

Here, n₁ is the number of complete revolutions for the first gearwheel 13, as mentioned above, β₁ is the actual rotation angle of the first rotation angle sensor 15.1 or 15.2, and γ₁ denotes the first absolute angle offset determined for the first gearwheel 13.

Similarly, in the second channel B, the second absolute rotation angle α₂ is determined in method step 201_{B} based on the following formula:

$${α}_{2} = {n}_{2} * 360 ° + {β}_{2} + {γ}_{2} .$$

Here, n₂ is the number of complete revolutions for the second gearwheel 14, β₂, as mentioned above, is the actual rotation angle of the second rotation angle sensor 16.1 or 16.2, and γ₂ denotes the second absolute angle offset determined for the second gearwheel 13.

Output variables 18_{A} and 18_{B} of the first channel A and second channel B are therefore the first absolute rotation angle α₁ and the second absolute rotation angle α₂, both of which are ASIL-B compliant due to the initial synchronization.

In method step 202, the absolute rotation angles α₁ and α₂ are compared in conjunction with a diagnosis, in particular in the sense of a plausibility check. If the plausibility check is successful, the controller unit 11 provides a (plausibilized) absolute rotation angle L as output variable 19, also referred to herein as the absolute rotation angle. As a result of the ASIL-B conformity of the absolute rotation angle α₁ and α₂, the absolute rotation angle L is ASIL-D compliant and is therefore particularly suitable for electronic control tasks of an electronic or electric steering system. It should be noted that channels A and B are only assigned to one of the controller units 11, which means that two ASIL-D-compliant rotation angles are present when both controller units 11 are functioning correctly. If one of the controller units 11 fails, there is still an ASIL-D-compliant rotation angle, which is then determined by the controller unit 11 that is still working.

It is clear from the above descriptions that the method proposed here solves the underlying problem.

List of reference signs

| | |
|---|---|
| 1 | steering system |
| 2 | steering wheel |
| 3 | steering column |
| 4 | steering shaft |
| 5 | steering gear |
| 6 | further steering components |
| 7 | steered wheel |
| 8 | rotation angle sensor unit |
| 9 | sensor component |
| 10 | control unit |
| 11, 11.1, 11.2 | controller unit |
| 12 | axis of rotation |
| 13 | first gearwheel |
| 14 | second gearwheel |
| 15.1, 15.2 | first rotation angle sensor |
| 16.1, 16.2 | second rotation angle sensor |
| 17A, 17B | input variables |
| 18A, 18B | output variables |
| 19 | output variable |
| 101-108 | method steps |
| 201, 202 | method steps |
| A, B | channels |
| w | relative rotation angle |
| L | absolute rotation angle |

1. A method for operating a rotation angle sensor unit for use in steering systems of motor vehicles at a predetermined vehicle safety integrity level, wherein the rotation angle sensor unit is designed to determine an absolute rotation angle of a steering component, wherein the rotation angle sensor unit has an intermeshing gearwheel pair with parallel axes of rotation and different diameters, wherein a first gearwheel of the gearwheel pair is provided to be connected to the steering component for conjoint rotation and in a rotationally synchronized manner and a second gearwheel of the gearwheel pair is mounted in a rotationally fixed manner with respect to the first gearwheel, wherein two first rotation angle sensors are assigned to the first gearwheel and two second rotation angle sensors are assigned to the second gearwheel, which rotation angle sensors are each set up to detect a relative rotation angle of the respective gearwheel, wherein the rotation angle sensor unit further comprises a control unit with two independent controller units, wherein each controller unit is assigned a first and a second rotation angle sensor, and the controller units are in each case set up to determine and provide an absolute rotation angle of the steering component from rotation angle data of a respectively assigned first and/or second rotation angle sensor, the method comprising:
for operating the rotation angle sensor unit with the specified vehicle safety integrity level, at the time of initialization of the rotation angle sensor unit, determining, by each controller unit, an initial absolute rotation angle for the steering component using rotation angle data from the respectively assigned first and second rotation angle sensor, and the controller units are initially synchronized once with respect to the determined initial absolute rotation angles; and
after initial synchronization, continuously determining, by each controller unit, a first and second absolute rotation angle of the steering component from rotation angle data of an associated first rotation angle sensor on the one hand and from rotation angle data of an associated second rotation angle sensor on the other hand and combines these in a plausibilized manner to form an absolute rotation angle of the steering component.

2. The method according to claim 1, wherein the vehicle safety integrity level corresponds to the ASIL-D classification.

3. The method according to claim 1, wherein the steering component is a steering shaft, a steering wheel or a steered wheel of the motor vehicle.

4. The method according to claim 1, wherein each of the controller units at the time of initialization:
determines a first difference between the initial absolute rotation angle and an initial relative rotation angle of the first gearwheel;
determines a second difference between the initial absolute rotation angle and an initial relative rotation angle of the second gearwheel; and
stores the first and second difference as the first and second absolute angle offset.

5. The method according to claim 4, wherein each of the controller units continuously determines a respective first and second absolute rotation angle after determining the first and second absolute angle offsets for the steering component;
wherein the first absolute rotation angle is determined based on a respective actual rotation angle of the first gearwheel and the first absolute angle offset;
wherein the second absolute rotation angle is determined based on a respective relative actual rotation angle of the second gearwheel and the second absolute angle offset;
wherein the respective controller unit compares the determined first and second absolute rotation angles for diagnostic purposes and combines them to form the absolute rotation angle of the steering component.

6. The method according to claim 5, wherein after initialization and synchronization the first and second absolute rotation angle is calculated by the controller unit from a number of total revolutions of the first or second gearwheel, the respective actual rotation angle of the first and second gearwheel and the first second absolute angle offset, respectively.

7. The method according to claim 5, wherein the first and second absolute rotation angles are each calculated according to the following formula:
$${α}_{1 , 2} ( β ) = \sum {n}_{1 , 2} * 360 ° + {β}_{1 , 2} + {γ}_{1 , 2} ,$$
wherein:
α_{1, 2} is the first and second absolute rotation angle, respectively,
n_{1, 2} is the number of complete revolutions of the first and second gearwheel, respectively,
β_{1, 2} is the actual rotation angle of the first and second gearwheel, respectively, and
γ_{1, 2} is the first and second absolute angle offset, respectively.

8. The method according to claim 1, wherein the rotation angle sensor unit is designed to determine an absolute rotation angle of a steering wheel.

9. A rotation angle sensor unit configured to perform a method according to claim 1, the rotation angle sensor unit comprising:
a control unit with two independent controller units, wherein the controller units are programmed in such a way that, in operation, they effect the method, or have an associated non-volatile memory on which instructions executable by a processor, of the controller units are stored, which instructions, when executed by the processor, effect the method.

10. The rotation angle sensor unit according to claim 9, wherein the processor is a microprocessor.

11. The rotation angle sensor unit according to claim 9, designed as a rotation angle sensor unit for a steering component of a motor vehicle, wherein the absolute rotation angle corresponds to an absolute rotation angle of a steering shaft, a steering wheel and/or corresponds to an absolute rotation angle of a steered wheel of the motor vehicle.

12. The rotation angle sensor unit according to claim 9, wherein the controller units are implemented in a redundant control unit or in separate control units.

13. A steering system, for a motor vehicle comprising at least one rotation angle sensor unit according to claim 9.

14. The steering system of claim 13, wherein the steering system is a steer-by-wire steering system.
